(19) United States
(12) Patent Application Publication
(10) Pub. No.: US 2024/0212211 A1
(43) Pub. Date: Jun. 27, 2024

(54) SOLID-STATE IMAGING DEVICE, INFORMATION PROCESSING SYSTEM, INFORMATION PROCESSING DEVICE, AND NON-TRANSITORY COMPUTER READABLE MEDIUM

(71) Applicant: Gildas TUFFIN, Tokyo (JP)

(72) Inventor: Gildas TUFFIN, Tokyo (JP)

(21) Appl. No.: 18/544,452

(22) Filed: Dec. 19, 2023

(30) Foreign Application Priority Data
Dec. 21, 2022 (JP) 2022-204800

(51) Int. Cl. G06T 7/80; G06T 7/00

(52) U.S. Cl. CPC G06T 7/80; G06T 7/97; G06T 2207/10028

(57) ABSTRACT

A solid-state imaging device includes an imaging unit, a memory, and a processor. The imaging unit acquires first image information and first depth information. The processor is configured to generate a first non-rigid model based on the first depth information, fit the first non-rigid model and a second non-rigid model which is based on second depth information acquired by at least one other solid-state imaging device, acquire external parameters related to the other solid-state imaging device based on the fitting result.

### CROSS REFERENCE TO THE RELATED APPLICATIONS

This application is based upon and claims the benefit of priority from the Japanese Patent Application No. 2022-204800, filed on Dec. 21, 2022, the entire contents of which are incorporated herein by reference.

### FIELD

The present disclosure relates to a solid-state imaging device, an information processing system, an information processing device, and a non-transitory computer readable medium.

### BACKGROUND

To create a real-time 3D hologram of an object, multiple cameras must be coordinated to capture different views of the object. In this process, it is important to mutually know the exact positions and directions of all cameras. This is because certain sides of the object viewed by one camera need to be properly positioned relative to other sides seen by other cameras.

The exact position and orientation of all cameras relative to each other is achieved through external calibration. This external calibration is performed after each camera's own calibration, thus ensuring the optical accuracy (RGB+depth) of each camera. These two calibrations are usually performed as a prerequisite for hologram generation. However, it is difficult to accurately acquire these data, which poses a problem in generating highly accurate holograms.

### SUMMARY

Embodiments relate to a solid-state-imaging device. The solid-state-imaging device includes an imaging unit acquires first image information and first depth information, a storage unit, and a processing circuit. The processing circuit is configured to: generate a first non-rigid model based on the first depth information; fit the first non-rigid model and a second non-rigid model which is based on second depth information acquired by at least one other solid-state imaging device; and acquire external parameters related to the other solid-state imaging device based on a fitting result. For example, the first camera 20A acquires first image information which is an RGB image, and first depth information which is depth information, using the imaging unit, and the second camera 20B acquires a non-rigid model based on the first depth information. It is possible to obtain the external parameters of the first camera 20A with respect to the second camera 20B by fitting the non-rigid model based on the second depth information obtained.

In one or more embodiments, n the processing circuit obtains the second non-rigid model from the other solid-state imaging device. For example, the first camera 20A may acquire information about the second non-rigid model generated by the second camera 20B from the second camera 20B.

In one or more embodiments, the processing circuit acquires the second depth information from the other solid-state imaging device and generates the second non-rigid model. For example, the first camera 20A may obtain the second depth information from the second camera 20B to generate the second non-rigid model.

In one or more embodiments, the processing circuit acquires an external parameter for converting a camera coordinate system in the other solid-state imaging device to a camera coordinate system in the own solid-state imaging device. For example, the first camera 20A can acquire external parameters for converting the second camera coordinate system of the second camera 20B to the first camera coordinate system of the first camera 20A. Further, the acquired information may be information regarding the reverse transformation, that is, the first camera 20A can also acquire external parameters for transforming from the first camera coordinate system to the second camera coordinate system.

In one or more embodiments, the processing circuit obtains the external parameters by fitting the first non-rigid model and the second non-rigid model obtained at arbitrary timing, and stores the external parameters in the storage unit. The first camera 20A may obtain external parameters based on an implementation such as Surfel, which is a non-limiting example method.

In one or more embodiments, wherein the processing circuit inputs the first depth information into a trained model to generate the first non-rigid model. The processing circuit may further infer and obtain a non-rigid model using a trained model that generates a non-rigid model from depth information.

In one or more embodiments, at least one solid-state imaging device of the plurality of solid-state imaging devices acquires external parameters regarding other solid-state imaging devices. For example, two cameras may be used to obtain the above external parameters, or three or more cameras may be used to obtain the above external parameters.

Embodiments also relate to an information processing device. The information processing device includes a storage unit; and a processing unit. The processing unit is configured to: fit a first non-rigid model based on a first depth information acquired by a first imaging device and a second non-rigid model based on a second depth information acquired by a second imaging device; and acquire external parameters of a second imaging device coordinate system at the second imaging device regarding a first camera coordinate system at the first imaging device based on a fitting result. In the above, it is assumed that the camera is equipped with a processing circuit, but the embodiment is not limited to this, and processing similar to any of the above can be realized in an information processing device that is directly or indirectly connected to the multiple cameras.

Embodiments also relate to an information processing device. The information processing device includes a storage device; and a processing circuit. The processing circuit is configured to: fit a first non-rigid model based on a first depth information acquired by a first imaging device and a second non-rigid model based on a second depth information acquired by a second imaging device; and acquire external parameters of a second imaging device coordinate system at the second imaging device regarding a first camera coordinate system at the first imaging device based on a fitting result. A program may cause the processing circuit to execute an information processing method to acquire external parameters of the first imaging system with respect to the second imaging system based on a fitting result. In this way, the above implementation may be written in a program.

### BRIEF DESCRIPTION OF DRAWINGS

FIG. 1 is a block diagram schematically showing an example of an information processing system according to an embodiment.

FIG. 2 is a flowchart illustrating an example of processing of an information processing system according to an embodiment.

FIG. 3 is a block diagram schematically showing an example of an information processing system according to an embodiment.

FIG. 4 is a flowchart illustrating an example of processing of the information processing system according to an embodiment.

FIG. 5 is a block diagram schematically showing an example of an information processing system according to an embodiment.

FIG. 6 is a flowchart illustrating an example of processing of the information processing system according to an embodiment.

### DETAILED DESCRIPTION

According to one embodiment, a solid-state imaging device includes an imaging unit, a memory, and a processor. The imaging unit acquires first image information and first depth information. The processor is configured to generate a first non-rigid model based on the first depth information, fit the first non-rigid model and a second non-rigid model which is based on second depth information acquired by at least one other solid-state imaging device, acquire external parameters related to the other solid-state imaging device based on the fitting result.

Embodiments will be described below with reference to the drawings.

### First Embodiment

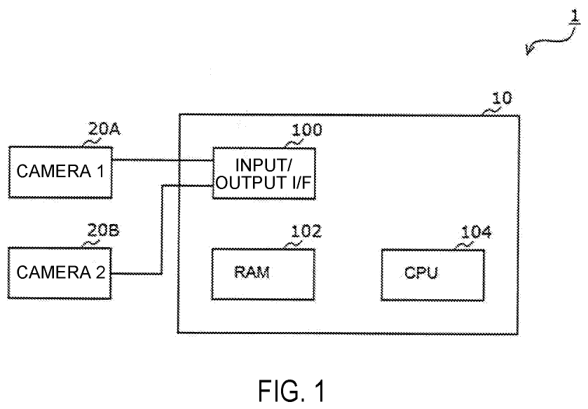

FIG. 1 is a block diagram schematically showing an example of an information processing system according to an embodiment. The information processing system 1 is a system that uses two cameras to execute predetermined processing, SLAM (Simultaneous Localization and Mapping), or any processing using the results of SLAM, such as hologram generation processing. The information processing system 1 may include an information processing device 10, a first camera 20A, and a second camera 20B.

The information processing device 10 may include an input/output interface (hereinafter referred to as input/output I/F 100), a storage unit 102, and a processing circuit 104. The information processing device 10 may be a device that automatically acquires external parameters between the imaging systems based on data acquired from two different imaging systems. Furthermore, the information processing device 10 can also process images acquired from the two imaging systems based on this external parameter.

The input/output I/F 100 includes at least one interface for inputting and outputting necessary data between the inside and outside of the information processing device 10, and can be any wired or wireless interface for inputting and outputting the necessary data. Further, the information processing device 10 may include a user interface as an input/output I/F 100 through which a user can directly input and output data.

The storage unit 102 stores data necessary for processing in the information processing device 10. Furthermore, the storage unit 102 may store data processed by the information processing device 10. The storage unit 102 can have any form of temporary or non-temporary storage circuitry. At least a portion of the storage unit 102 may be provided outside the information processing device 10 and may be configured to be able to input and output data to and from the information processing device 10 via the input/output I/F 100.

The processing circuit 104 is a circuit that executes processing in the information processing device 10. The processing circuit 104 is, for example, a digital circuit or analog circuit such as an ASIC (Application Specified Integrated Circuit) capable of dedicated processing, a programmable circuit such as an FPGA (Field Programmable Gate Array), or a CPU (It can be equipped with any processor such as a Central Processing Unit. Furthermore, an accelerator may be included as part of the processing circuit 104. The information processing device 10 may include a plurality of processing circuits as the processing circuit 104.

It may be possible to specifically implement information processing by software using the processing circuit 104 which is hardware. In this case, the processing circuit 104 may implement a specific process by reading out a program, an executable file, etc. for executing the process stored in the storage unit 102.

The processing circuit 104 obtains external parameters between the cameras, for example, based on data obtained from the two cameras. The processing circuit 104 may also perform processing using SLAM or the like based on the acquired external parameters.

The first camera 20A and the second camera 20B are imaging devices that acquire the external state of the information processing device 10. The first camera 20A and the second camera 20B, for example, photograph the same object from different positions and postures, and output the photographed data to the information processing device 10.

Alternatively, the information processing device 10 may be provided in either the first camera 20A or the second camera 20B. For example, the first camera 20A may include the information processing device 10 therein, and may acquire data captured by the second camera 20B. As a non-limiting example, the first camera 20A and the second camera 20B may be RGB-D cameras arranged at different positions and postures.

Each camera is a solid-state imaging device having the above characteristics.

External parameters are parameters that convert the world coordinates where the object to be photographed exists into camera coordinates that are camera-specific coordinates. When a point in the world coordinate system is represented by, a point in the camera coordinate system [xc, yc, zc] can be represented as shown in equation (1) below.

$$[ \begin{matrix}{x}_{c} \\ {y}_{c} \\ {z}_{c} \\ 1\end{matrix} ] = [ \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ 0 & 0 & 0 & 1\end{matrix} ] [ \begin{matrix}{x}_{w} \\ {y}_{w} \\ {z}_{w} \\ 1\end{matrix} ] \qquad ( 1 )$$

These a11, . . . , a34 are called external parameters. Typically, a11 to a33 represent matrices representing rotation, a14 to a34 represent vectors representing translation, and the equation as a whole represents an affine transformation from the world coordinate system to the camera coordinate system. In the present disclosure, for example, the external parameter shown in equation (1) is obtained using any method.

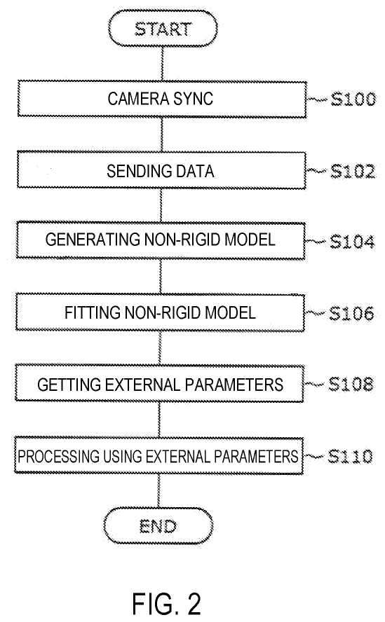

FIG. 2 is a flowchart showing processing according to this embodiment.

First, the first camera 20A and the second camera 20B are synchronized (S100). This synchronization can be performed, for example, by transmitting and receiving timing signals using processing circuits provided inside the first camera 20A and the second camera 20B. Further, the information processing device 10 may synchronize two cameras, or the information processing device 10 may synchronize data based on the imaging timing of the two cameras.

After the synchronization is completed, the first camera 20A and the second camera 20B transmit data captured at a certain timing to the information processing device 10 (S102). Information processing device 10 acquires data from two cameras via input/output I/F 100. The information processing device 10 may store the acquired data in the storage unit 102 as necessary. The first camera 20A and the second camera 20B each acquire, for example, RGB data and depth data at the same timing.

The processing circuit 104 generates a non-rigid model for each camera based on the depth data acquired from each camera (S104). A non-rigid model can be generated using any method.

The processing circuit 104 fits the generated non-rigid model (S106). For example, the processing circuit 104 executes fitting so as to link each feature point in the generated non-rigid model.

For example, the processing circuit 104 applies a non-rigid model obtained from information captured by the second camera 20B to a non-rigid model obtained from information captured by the first camera 20A, which is known reference information. Execute fitting using the depth information at each camera, processing circuitry 104 generates a non-rigid model at each camera.

The processing circuit 104 fits the non-rigid model by comparing the feature points in the non-rigid model generated from the information acquired by each camera. For example, the processing circuit 104 associates feature points indicating the same point in each non-rigid model, and associates coordinates (location) in the camera coordinate system of each camera. Any method can be used to extract the feature points.

The processing circuit 104 obtains external parameters based on the fitting data obtained in S106 (S108). The processing circuit 104 obtains, for example, the direction of the lens of the first camera 20A and the first coordinates based on the origin, that is, the external parameters of the second camera 20B with respect to the camera coordinates of the first camera 20A. The processing circuit 104 may also acquire external parameters of the first camera 20A based on the second coordinates, which are the camera coordinates of the second camera 20B.

The processing in S106 and S108 can be executed as a continuous process by focusing on local microsurfaces of the non-rigid model generated from the depth information acquired by each camera and fitting these microsurfaces, for example. (for example, using the SurfelWrap method introduced in arXiv:1904.13073v1). In this approach, a transformation matrix between the two cameras (e.g., extrinsic parameters of the second camera 20B with respect to the first camera 20A) can be generated such that the value of the fitting error is smaller than a threshold.

The processing circuit 104 can store the acquired external parameters in the storage unit 102 and read them at necessary timing.

Further, as in general processing, world coordinates may be set, and the processing circuit 104 sets external parameters of the first camera 20A based on the relationship between the first camera 20A and the second camera 20B. From this, it is also possible to obtain the external parameters of the second camera 20B based on the above fitting results. For example, when the first camera 20A is fixed, the external parameters of the second camera 20B for the camera coordinate system of the first camera 20A are determined based on the fixed external parameters of the first camera 20A. This means that external parameters of common world coordinates can be obtained.

This external parameter allows the processing circuit 104 to obtain conversion data of RGB data captured by the other camera with one camera as a reference. That is, the processing circuit 104 can execute arbitrary processing using external parameters (S110). The processing circuit 104 can also execute processing using SLAM, for example, by using this external parameter.

The processing circuit 104 is also capable of converting the captured RGB images into the image coordinate system in each camera. This conversion can be implemented using internal parameters of each camera that have been acquired in advance.

As described above, according to the information processing system 1 according to the present embodiment, by acquiring data from two cameras, the information processing device 10 automatically calculates relative external parameters of a plurality of cameras becomes possible. Since this external parameter is generated based on photographed depth information, it is also possible to process it in real time. It is also possible to consider that the camera coordinates of one camera match the world coordinates, and in this case, other cameras can improve the calculation cost by calculating external parameters for this one camera.

### Second Embodiment

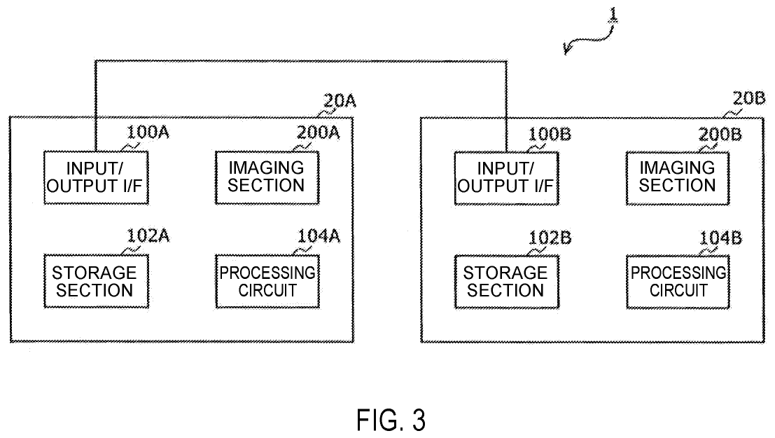

FIG. 3 is a block diagram schematically showing an example of an information processing system according to an embodiment.

The information processing system 1 includes a first camera 20A and a second camera 20B. On the other hand, unlike the first embodiment described above, the information processing system 1 does not need to include the information processing device 10.

The first camera 20A includes, for example, an imaging section 200A, an input/output I/F 100A, a storage section 102A, and a processing circuit 104A. The imaging unit 200A includes, for example, an optical system such as a lens and an imaging element, and acquires an image of the target based on the position and orientation of the first camera 20A. The imaging unit 200A stores the acquired image information in the storage unit 102A, and if necessary, the acquired image is processed in the processing circuit 104A.

The input/output I/F 100A, the storage unit 102A, and the processing circuit 104A may have the same configuration as the information processing device 10 in the above-described embodiment with the same reference numerals.

Similarly, the second camera 20B includes an imaging section 200B, an input/output I/F 100B, a storage section 102B, and a processing circuit 104B, and has the same functions as the first camera 20A.

For the first camera 20A and the second camera 20B, respective external parameter information (internal parameter information may also be included) is stored in the storage units 102A and 102B.

The first camera 20A and the second camera 20B are connected to each other via respective input/output I/Fs 100A and 100B. The connection may be wireless, such as Bluetooth (registered trademark), Bluetooth Low Energy: BLE (registered trademark), Wi-Fi, or a method in which part of the route includes a wired connection.

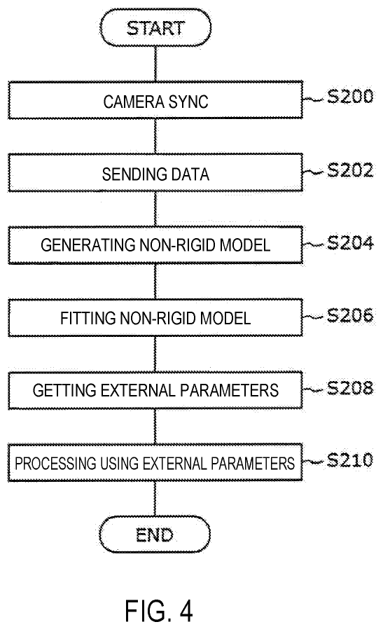

FIG. 4 is a flowchart illustrating an example of processing of the information processing system 1 according to an embodiment.

First, the first camera 20A and the second camera 20B perform a synchronous operation so that they can acquire images at the same timing (S200).

Next, the processing circuit 104A and the processing circuit 104B generate a non-rigid model from the image information captured by the imaging unit 200A and the imaging unit 200B, respectively (S202). For example, each processing circuit may generate a non-rigid model based on the depth information acquired by each imaging unit, similarly to the embodiment described above.

After generating the non-rigid model, the processing circuit 104A and the processing circuit 104B share the acquired non-rigid model via the input/output I/F (S204). Specifically, the processing circuit 104A of the first camera 20A transmits the generated non-rigid model via the input/output I/F 100A, and acquires the non-rigid model transmitted from the second camera 20B. Similarly, the processing circuit 104B of the second camera 20B transmits the generated non-rigid model via the input/output I/F 100B, and also acquires the non-rigid model transmitted from the first camera 20A. In this way, two cameras share a non-rigid model by transmitting the non-rigid model that they have generated and receiving the non-rigid model that the other camera has generated.

The processing circuit of each camera fits the non-rigid model it generated and the received non-rigid model (S206).

The processing circuits 104A and 104B of each camera obtain external parameters based on the results of the fitting performed in S206 (S208).

As a non-limiting example, the first camera 20A obtains the external parameters of the first camera 20A with respect to the second camera 20B based on the fitting results of the generated non-rigid model of itself and the non-rigid model obtained from the second camera 20B. Similarly, the second camera 20B may further acquire external parameters of the second camera 20B with respect to the first camera 20A. It is not necessary for both cameras to acquire the external parameters of the other camera, and any configuration that allows either camera to acquire the external parameters for the other camera as a reference is sufficient.

As another non-limiting example, a world coordinate system is defined based on the position and orientation of the first camera 20A, and the second camera 20B obtains external parameters for the world coordinate system based on the fitting results of a non-rigid model. In this way, it is also possible to use external parameters based on a coordinate system with one of the cameras as a reference.

Each of the processing circuits 104A and 104B executes necessary processing based on the external parameters acquired by each (S210). For example, each processing circuit can create a three-dimensional hologram based on external parameters and image information acquired by itself.

As described above, according to the present embodiment, a plurality of cameras and at least one processing circuit for realizing processing of the cameras are used in the same manner as in the first embodiment without separately providing the information processing device 10 as a computer. With this configuration, it is possible to set external parameters in real time and generate three-dimensional holograms, etc. using a system equipped with the at least one processing circuit and imaging systems such as two digital cameras, two smartphones, tablet terminals, or etc.

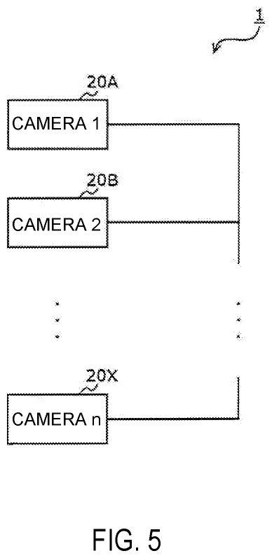

FIG. 5 is a block diagram schematically showing an example of an information processing system according to an embodiment. As shown in FIG. 5, the number of cameras does not need to be two, and more cameras may be provided.

For example, the information processing system 1 includes n cameras, a first camera 20A, a second camera 20B, . . . , an n-th camera 20X, each of which generates a non-rigid model of a target, and by sharing the model, external parameters for the world coordinate system can be obtained.

In this case, one camera may share a non-rigid model with all cameras. Alternatively, a camera that shares a non-rigid model may be determined for each camera, and external parameters between the camera and the determined camera may be acquired. In this case, all cameras are connected to the reference world coordinate system. It is desirable to obtain external parameters that are connected directly or indirectly through some other camera.

As an example, with the first camera 20A as the reference, all cameras share the non-rigid model calculated by the first camera 20A, obtain external parameters between them and this first camera 20A, and use these external parameters.

As another non-limiting example, the second camera 20B obtains external parameters relative to the first camera 20A, and the third camera 20C obtains external parameters relative to the second camera 20B. Each camera may generate external parameters that are referenced to different cameras.

In this case, it is desirable that all of the plurality of cameras be established as one group by making reference from or to one camera. That is, it is desirable that all cameras of interest form one connected group according to relative external parameters. For example, when all cameras are referencing/referenced via external parameters like this, regarding the back side of the object (information that cannot be obtained from the first camera 20A) in the image obtained from the first camera 20A, if there exist at least one camera that obtains at least part of the information of both the side photographed by the first camera 20A and the side photographed by the camera on the rear side, via the external parameters of the at least one camera against the first camera 20A and the rear side camera, the system can obtain appropriate SLAM information by passing it through the external parameters.

As an example, in the above case, the first camera 20A may be fixed.

As an example, both the first camera 20A and the second camera 20B may be fixed.

As an example, in the above case, by calculating the self-position of the first camera 20A with respect to the world coordinate system, all cameras can share the external parameters of the first camera 20A with respect to the world coordinate system, and all the cameras may also acquire external parameters for the world coordinate system.

FIG. 5 may include at least one information processing device 10 according to the first embodiment. The information processing device 10 may acquire external parameters of all cameras, or may acquire external parameters of one or more predetermined cameras.

In the latter case, based on the relationship with the camera from which the information processing device 10 has acquired the external parameters, another camera acquires the external parameters from the camera from which the information processing device 10 has acquired the external parameters, and transmits the information. The processing device 10 may correct its own external parameters based on the acquired external parameters.

By using three or more cameras, for example, it is also possible to accurately form a three-dimensional hologram based on information that cannot be sensed by the first camera 20A.

### Third Embodiment

In each of the embodiments described above, a mode has been described in which external parameters between a plurality of cameras are acquired using a processing circuit. In this embodiment, updating of acquired external parameters will be further described.

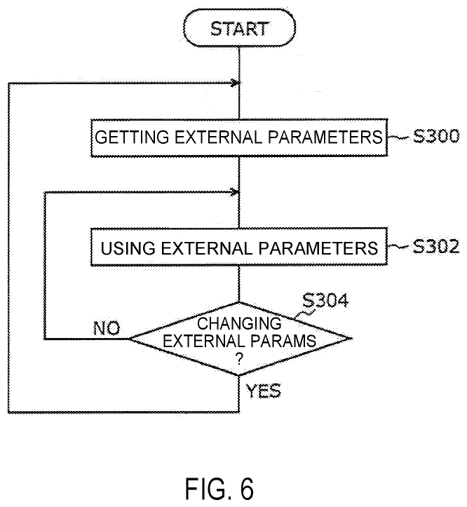

FIG. 6 is a flowchart illustrating an example of processing of the information processing system 1 according to an embodiment.

The information processing system 1 acquires external parameters from multiple cameras (S300). This process is similar to the acquisition of external parameters in each of the embodiments described above.

Next, the information processing system 1 executes processing based on the obtained parameters (S302). This process is also similar to the process in each of the embodiments described above.

Next, the processing circuit 104 determines whether it is necessary to update the external parameters (S304). If it is necessary to update the external parameters (S304: YES), the processing circuit obtains the external parameters and updates the external parameters (S300). If the external parameters do not need to be updated (S304: NO), the processing circuit 104 continues to perform processing using the external parameters (S302). For example, the processing circuit 104 may repeat the operation of acquiring external parameters at the timing at which it wants to start creating a three-dimensional hologram. For example, the processing circuit 104 may update the external parameters at the timing when the target for which a three-dimensional hologram is to be created becomes a different target.

Furthermore, the processing circuit 104 can also update the external parameters at any subsequent timing. For example, the processing circuit 104 may acquire external parameters at predetermined intervals, or may acquire some kind of index that can be acquired when generating a three-dimensional hologram (for example, an error value indicating the degree of consistency with other cameras, etc.) may be used to regenerate external parameters.

Further, the processing circuit 104 may, for example, repeatedly execute the process up to calculating the fitting error, and re-acquire the external parameters at the timing when this error becomes larger than a predetermined error.

As yet another example, the processing circuit 104 acquires the self-position and orientation by SLAM, and calculates the external parameters at a timing when the current position and orientation deviate by a predetermined value or more from the timing at which the external parameters were acquired before. The processing circuit 104 may not use SLAM, but may regenerate external parameters at the timing when the position or orientation shifts based on, for example, the sensing results of a 6-axis sensor or gyro sensor, or the results of analyzing images acquired by a camera.

In any of the above external parameter updates, the information processing system 1 may update the external parameters of all cameras at the same timing, or update the external parameters of cameras that meet the conditions that require updating of external parameters, respectively.

As described above, by updating external parameters at arbitrary timing, information processing system 1 can obtain highly accurate external parameters and achieve highly accurate information processing using these external parameters.

### Fourth Embodiment

In addition to the above configuration, the processing circuit 104 can improve the non-rigid model using the trained model. The storage unit 102 stores, for example, parameters related to a trained model that generates a non-rigid model from human movements trained in advance by machine learning (including Deep Learning), and the processing circuit 104 stores parameters related to a trained model that generates a non-rigid model from human movements, and the processing circuit 104 stores parameters related to a trained model that generates a non-rigid model from human movements that have been trained in advance by machine learning. A non-rigid model may be generated from depth information captured using a trained model.

By using such a trained model, for example, by estimating information on the back side (rear side) of the target person that cannot be obtained from the image taken by the first camera 20A, more accurate SLAM can be obtained from the two cameras.

Although several embodiments of the invention have been described, these embodiments are presented by way of example and are not intended to limit the scope of the invention. These novel embodiments can be implemented in various other forms, and various omissions, substitutions, and changes can be made without departing from the spirit of the invention. These embodiments and their modifications are included within the scope and the spirit of the invention, as well as within the scope of the invention described in the claims and its equivalents.

What is claimed is:

1. A solid-state imaging device comprising:
an imaging unit acquiring first image information and first depth information;
a memory; and
a processor configured to:
generate a first non-rigid model based on the first depth information;
fit the first non-rigid model and a second non-rigid model which is based on second depth information acquired by at least one other solid-state imaging device; and
acquire external parameters related to the other solid-state imaging device based on a fitting result.

2. The solid-state imaging device according to claim 1, wherein
the processor acquires the second non-rigid model from the at least one other solid-state imaging device.

3. The solid-state imaging device according to claim 1, wherein
the processor acquires the second depth information from the at least one other solid-state imaging device and generates the second non-rigid model.

4. The solid-state imaging device according to claim 1, wherein
the processor acquires external parameters for converting a camera coordinate system of the at least one other solid-state imaging device to a camera coordinate system in the ego-solid-state imaging device.

5. The solid-state imaging device according to claim 4, wherein
the processor acquires the external parameters by fitting the first non-rigid model and the second non-rigid model, and stores the external parameters in the memory.

6. The solid-state imaging device according to claim 1, wherein
the processor inputs the first depth information into a trained model to generate the first non-rigid model.

7. An information processing system comprising a plurality of solid-state imaging device according to claim 1, wherein
at least one solid-state imaging device of the plurality of solid-state imaging device acquires external parameters regarding at least one other solid-state imaging device of the plurality of solid-state imaging device.

8. An information processing device comprising:
a memory; and
a processor configured to:
fit a first non-rigid model based on a first depth information acquired by a first imaging device and a second non-rigid model based on a second depth information acquired by a second imaging device; and
acquire external parameters of a second imaging device coordinate system at the second imaging device regarding a first camera coordinate system at the first imaging device based on a fitting result.

9. A non-transitory computer readable medium storing program which causes a processor to execute:
generate a first non-rigid model based on first depth information acquired by a first imaging system;
fit the first non-rigid model and a second non-rigid model based on second depth information acquired by a second imaging system; and
obtain external parameters of the first imaging system with respect to the second imaging system based on a fitting result.
